(19) United States
(12) Patent Application Publication
(10) Pub. No.: US 2016/0341219 A1
(43) Pub. Date: Nov. 24, 2016

(54) Single-phase Motor, Airflow Generating Device, And Electric Apparatus

(71) Applicant: Johnson Electric S.A., Murten (CH)

(72) Inventors: Yue Li, Hong Kong (CN); Chui You Zhou, Shenzhen (CN); Gang Li, Shenzhen (CN); Yong Wang, Shenzhen (CN); Yong Li, Shenzhen (CN); Wei Zhang, Shenzhen (CN); Ming Chen, Shenzhen (CN); Jie Chai, Shenzhen (CN); Kwong Yip Poon, Hong Kong (CN); Wen Liang Li, Shenzhen (CN); Lin Ping Gui, Shenzhen (CN)

(21) Appl. No.: 15/160,225

(22) Filed: May 20, 2016

(30) Foreign Application Priority Data
May 21, 2015 (CN) 201510262232.9
Aug. 18, 2015 (CN) 201510507014.7

(51) Int. Cl. F04D 29/66; H02K 1/27; H02K 5/16; F04D 17/16; A47L 5/12; F04D 29/28; F04D 29/44; F04D 29/42; A45D 20/00; A47K 10/48; H02K 1/14; F04D 25/06

(52) U.S. Cl. CPC F04D 29/661; H02K 1/148; H02K 1/2733; H02K 5/161; F04D 17/16; F04D 25/06; F04D 29/281; F04D 29/441; F04D 29/4226; A45D 20/00; A47K 10/48; A47L 5/12

(57) ABSTRACT

A single-phase motor, an airflow generating apparatus, and an electric apparatus are provided. The motor includes a stator and a rotor. The stator includes a stator core and stator windings. The stator core includes a ring-shaped yoke and multiple pole portions. A magnetic bridge or slot opening is formed between each two adjacent pole portions. An end surface of each pole portion includes an arc surface. A positioning groove is formed in each arc surface. The arc surfaces of the pole portions cooperatively form a receiving cavity. The rotor includes a rotary shaft and a permanent magnet fixed to the rotary shaft. The permanent magnet is received in the receiving cavity. The arc surfaces are located on a cylindrical surface centered around a rotation axis of the rotary shaft. The cogging torque of the motor can be reduced, thus reducing the startup current and hence the noise of the motor.

### CROSS REFERENCE TO RELATED APPLICATIONS

This non-provisional patent application claims priority under 35 U.S.C. §119(a) from Patent Application No.201510262232.9 filed in The People's Republic of China on May 21, 2015, and Patent Application No. 201510507014.7 filed in The People's Republic of China on Aug. 18, 2015.

### FIELD OF THE INVENTION

This invention relates to motors, and in particular, to a single-phase motor capable of high speed rotation and an electric apparatus such as a vacuum cleaner, a hand dryer and a hair dryer employing the motor.

### BACKGROUND OF THE INVENTION

In conventional single-phase motors, in order to avoid the start-up dead-point, the stator and rotor usually define an uneven gap there between. However, the motor with the uneven gap usually has a large cogging torque, which leads to large vibrations and noises.

### SUMMARY OF THE INVENTION

Thus, there is a desire for a single-phase motor with reduced cogging torque.

In one aspect, a single-phase motor is provided which includes a stator and a rotor. The stator includes a stator core and stator windings wound around the stator core, the stator core including a yoke and a plurality of asymmetrical pole portions extending inwardly from the yoke, a magnetic bridge or slot opening being formed between each two adjacent pole portions, each pole portion including an end surface with an arc surface facing the rotor, a positioning groove being formed in each arc surface, the arc surfaces of the plurality of pole portions cooperatively forming a receiving cavity in which the permanent magnet is received. The rotor includes a rotary shaft and a permanent magnet fixed to the rotary shaft. The permanent magnet is received in the receiving cavity formed between the first arc surface and the second arc surface.

Preferably, the arc surfaces are located at a cylindrical surface centered around a rotation axis of the rotary shaft, the permanent magnet and the arc surfaces define a substantially even gap there between.

Preferably, a slot opening is formed between each two adjacent pole portions and a width of the slot opening is less than or equal to three times the width of the even gap.

Preferably, a connecting line connecting a center of the magnetic bridge or slot opening and a center of the rotor and an extension direction of one of the pole portions form an angle of 60 to 65 degrees.

Preferably, the plurality of pole portions includes a first pole portion and a second pole portion opposed to each other along a diametrical direction of the rotor, the end surface of the first pole portion comprises the first arc surface and first and second cutting surfaces on opposite sides of the first arc surface, the end surface of the second pole portion comprises the second arc surface and third and fourth cutting surfaces on opposite sides of the second arc surface, the first cutting surface and the third cutting surface are opposed to each other and define the first slot opening there between, and the second cutting surface and the fourth cutting surface are opposed to each other and define the second slot opening there between.

Preferably, the first slot opening and the second slot opening have substantially the same size and are symmetrical about an axis of rotation of the rotor.

Preferably, a distance between the first cutting surface and the third cutting surface is 0.09 to 0.13 times an outer diameter of the rotor; and/or a distance between the second cutting surface and the fourth cutting surface is 0.09 to 0.13 times the outer diameter of the rotor.

Preferably, the stator core consists of a first half core portion and a second half core portion, the first half core portion forms a first half yoke portion and a first pole portion, the second half core portion forms a second half yoke portion and a second pole portion, and the first half yoke portion and the second half yoke portion are joined to form the ring-shaped yoke.

Preferably, a thickness of the gap is 0.26 to 0.34 times a thickness of the permanent magnet.

Preferably, a thickness of the permanent magnet is 0.2 to 0.24 times an outer diameter of the rotor.

Preferably, a width of the pole portion is 1.4 to 1.6 times an outer diameter of the rotor

Preferably, the yoke is a ring-shaped yoke and a thickness of the ring-shaped yoke is 0.5 to 0.7 times an outer diameter of the rotor.

Preferably, the positioning groove has an opening facing toward the permanent magnet, and a width of the opening of the positioning groove is 0.24 to 0.28 times an outer diameter of the rotor.

Preferably, the positioning groove has an opening facing toward the permanent magnet, and a depth of the positioning groove into the corresponding pole portion is 0.015 to 0.035 times an outer diameter of the rotor.

Preferably, a center of the positioning groove is aligned with a center line of a corresponding pole portion, and the end surface of the pole portion is asymmetrical about the center line of the pole portion.

Preferably, the stator further includes a housing having two half housing portions, each half housing portion includes a cylindrical sleeve, a hub disposed at an outer end of the cylindrical sleeve, and a plurality of spokes connected between the cylindrical sleeve and the hub, a bearing is mounted in the hub, the stator core is mounted to an inner wall surface of the cylindrical sleeve, opposite ends of the rotary shaft extend through the hubs of the two half housing portions and are supported by the bearings mounted in the hub, respectively.

In another aspect, an airflow generating device is provided which includes an impeller and a single-phase motor as provided above.

Preferably, the impeller is a centrifugal impeller driven by the rotary shaft of the single-phase motor. The centrifugal impeller includes an inlet at a center of the impeller, an outlet along an outer periphery of the impeller, and air passageways communicated between the inlet and the outlet. The airflow generating device further includes a diffuser disposed surrounding the centrifugal impeller. The diffuser includes a plurality of diffusing channels, and inlet ends of the diffusing channels are in flow communication with the outlet of the centrifugal impeller.

Preferably, the diffuser includes a cylindrical outer housing and a partition plate disposed within the outer housing. The partition plate is mounted to the single-phase motor. The cylindrical outer housing surrounds the single-phase motor, and the partition plate has a through bore for allowing the rotary shaft of the single-phase motor to pass there through.

Preferably, the diffusing channels extend through the partition plate.

In still other aspect, an electric apparatus such as a vacuum cleaner, a hand dryer, a hair dryer and the like are provided, which employ the airflow generating device as described above.

Embodiments of the present invention can reduce the cogging torque of the motor, thus reducing the startup current and hence the noise of the motor.

### BRIEF DESCRIPTION OF THE DRAWINGS

The present invention will be described below in detail with reference to the drawings and embodiments.

FIG. 1 illustrates a single-phase motor according to one embodiment of the present invention.

FIG. 2 illustrates the single-phase motor of FIG. 1, with a stator housing being removed.

FIG. 3 is an exploded view of a stator of the single-phase motor of FIG. 1.

FIG. 4 illustrates the single-phase motor of FIG. 1, with a winding bracket, a first insulating lining and a second insulating lining being removed.

FIG. 5 illustrates a stator core of the single-phase motor of FIG. 1.

FIG. 6 illustrates an airflow generating device according to another embodiment of the present invention.

FIG. 7 illustrates the airflow generating device of FIG. 6, with a diffuser being removed.

FIG. 8 illustrates a diffuser of the airflow generating device of FIG. 6.

FIG. 9 is a sectional view of the airflow generating device of FIG. 6.

FIG. 10 illustrates the airflow generating device of FIG. 6 which is utilized in a vacuum cleaner.

FIG. 11 illustrates the airflow generating device of FIG. 6 which is utilized in a hand dryer.

FIG. 12 illustrates the airflow generating device of FIG. 6 which is utilized in a hair dryer.

### DETAILED DESCRIPTION OF THE PREFERRED EMBODIMENTS

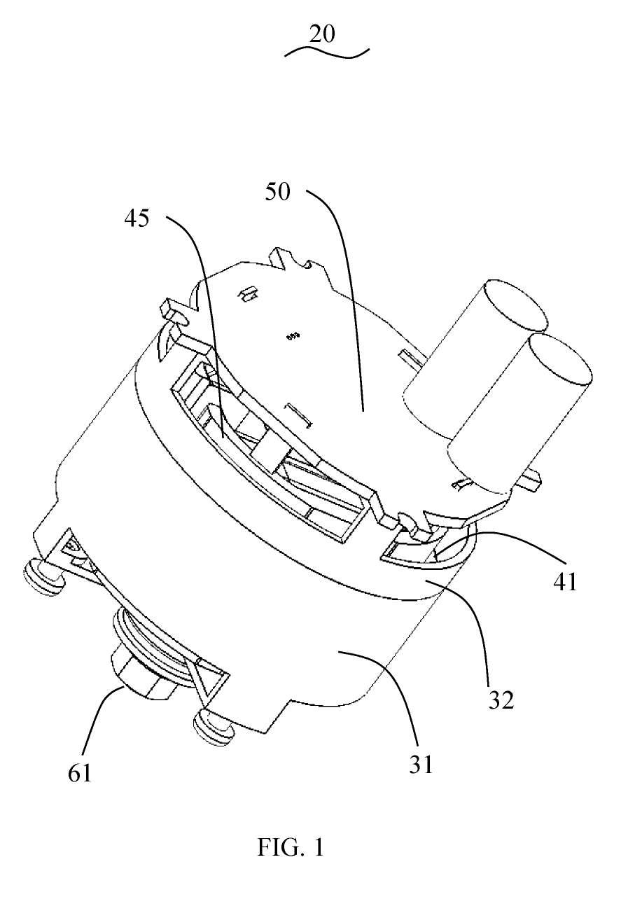

Referring to FIG. 1 through FIG. 3, a single-phase motor 20 in accordance with one embodiment of the present invention includes a stator and a rotor. The stator includes a stator housing, a stator core 41, stator windings 49 wound around the stator core 41, and a control circuit board 50 mounted to one end of the stator. The stator housing includes two half housing portions 31, 32. Each half housing portion includes a cylindrical sleeve, a hub 35 disposed at an outer end of the cylindrical sleeve, and a plurality of spokes 33 connected between the cylindrical sleeve and the hub 35. A bearing 37 is mounted in the hub 35. The stator core 41 is made from a magnetic-conductive material such as iron, which is mounted to an inner wall surface of the cylindrical sleeve. In this embodiment, the single-phase motor 20 is preferably a single-phase permanent magnet direct current brushless motor 20. The single-phase motor 20 may also be a permanent magnet synchronous motor in other embodiments.

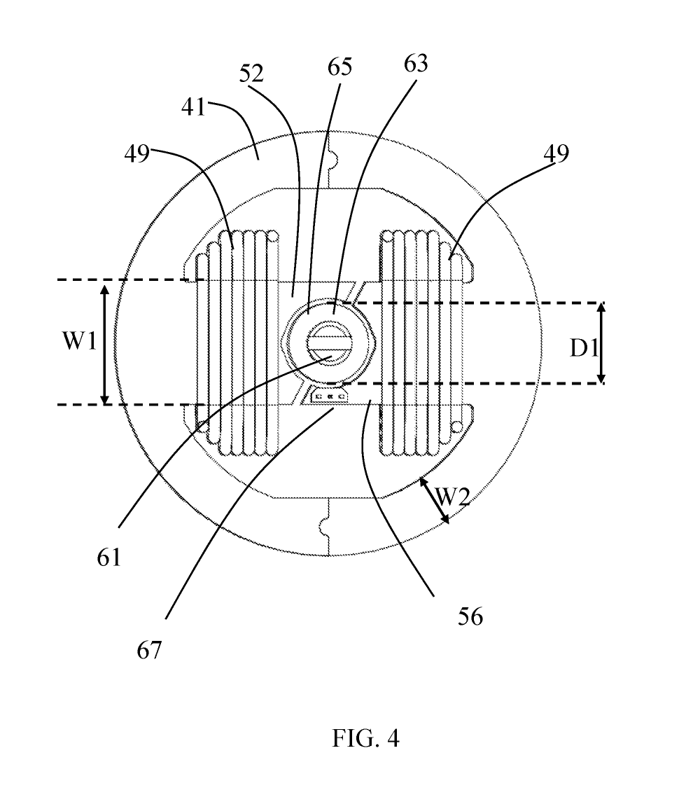

The rotor includes a rotary shaft 61 and a permanent magnet 63 (see FIG. 4) fixed to the rotary shaft 61. Preferably, a radial thickness of the permanent magnet 63 is 0.2 to 0.24 times of an outer diameter of the rotor. Opposite ends of the rotary shaft 61 extend through the hubs 35 of the two half housing portions 31, 32 and are supported by the bearings 37 mounted in the hubs 35, respectively.

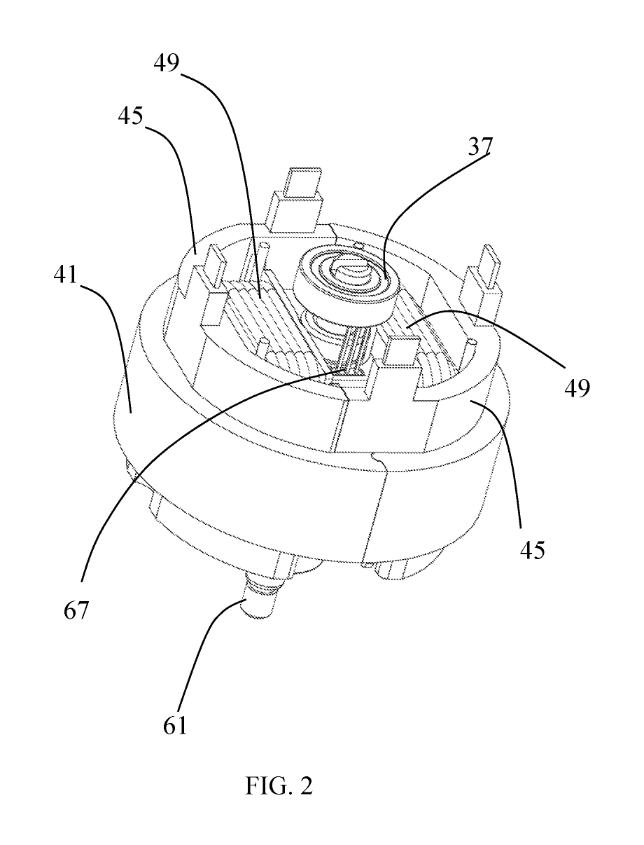

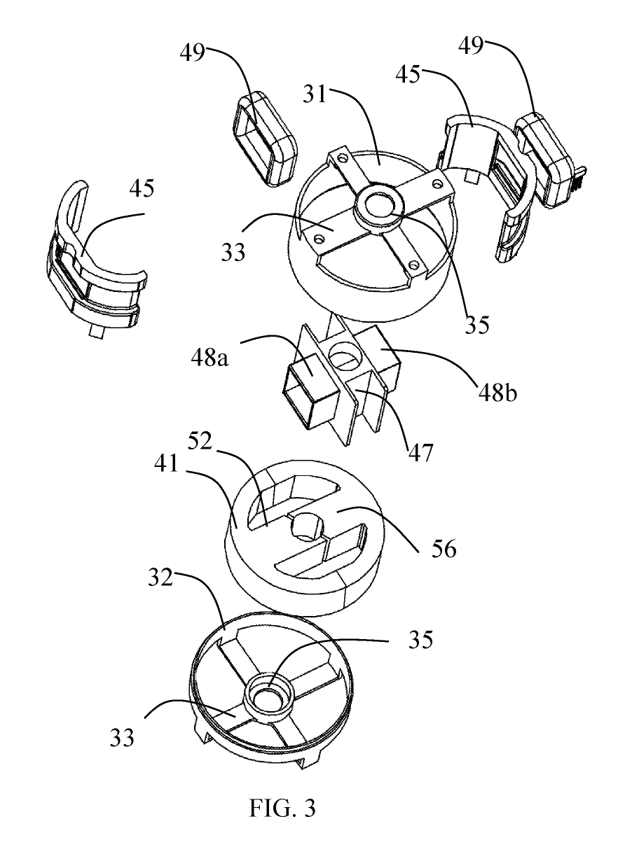

Referring to FIG. 2 and FIG. 3, an insulating bracket 47 is disposed between pole portions 52, 56 of the stator core 41 and the stator windings 49 for insulating the stator core 41 and windings 49. Two insulating member such as insulating linings 45 are disposed between an outer ring portion (i.e. yoke) of the stator core 41 and the two stator windings 49, respectively, for isolating the stator windings 49 from the stator core 41. In this embodiment, the insulating lining 45 is attached to an inner surface of the outer ring portion of the stator core 41 and has a through hole for allowing the corresponding pole portion 52 or 56 to pass there through.

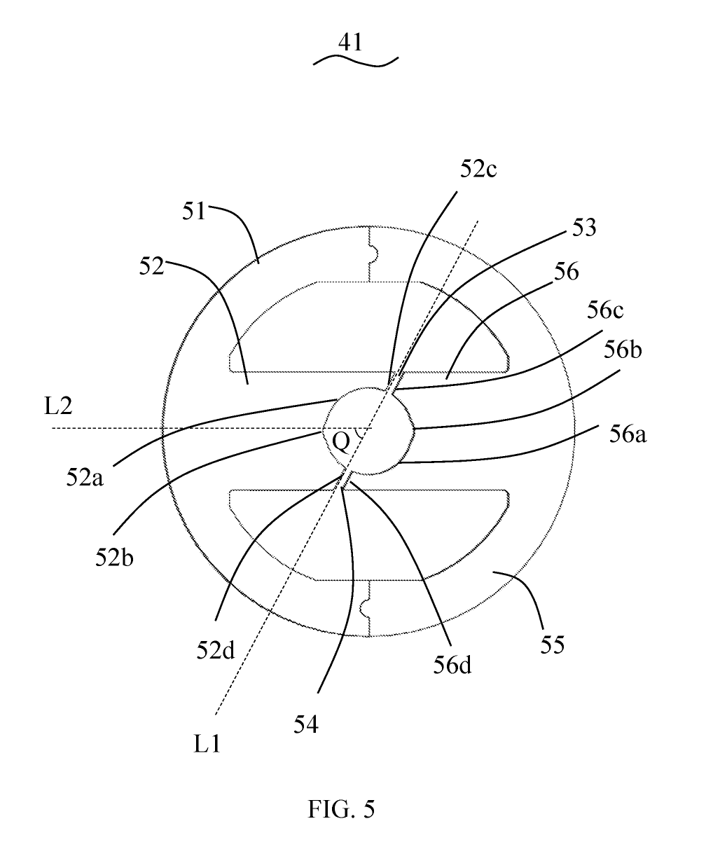

Referring to FIG. 4 and FIG. 5, the stator core 41 consists of a first half core portion and a second half core portion. Joining surfaces of the first half core portion and the second half core portion are provided with concave-convex inter-engagement structures. The first half core portion includes a first half yoke portion 51 and a first pole portion 52 extending from the first half yoke portion 51 toward a center of the stator core. The second half core portion includes a second half yoke portion 55 and a second pole portion 56 extending from the second half yoke portion 55 toward the center of the stator core. The first half yoke portion 51 and the second half yoke portion 55 cooperatively form a ring-shaped yoke 50.

The first pole portion 52 and second pole portion 56 have a width W1 perpendicular to the extension direction of the first pole portion 52, and the width W1 is 1.4 to 1.6 times of an outer diameter D1 of the rotor. The ring-shaped yoke 50 has a thickness W2 along a radial direction of the stator, and the thickness W2 of the ring-shaped yoke 50 is 0.5 to 0.7 times the outer diameter D1 of the rotor. The first pole portion 52 includes a first arc surface 52a with a first positioning groove 52b formed therein. The second pole portion 56 includes a second arc surface 56a with a second positioning groove 56b formed therein. The first positioning groove 52b and the second positioning groove 56b face to each other along a diametrical direction of the rotor, for controlling the initial/stop position of the rotor relative to the stator when the motor is de-energized. The stop position or initial position of the rotor can be adjusted by adjusting the positions of the positioning grooves 52b, 56b. The first arc surface 52a and the second arc surface 56a face to each other to form a receiving cavity there between in which the permanent magnet 63 is received. The permanent magnet 63 forms two permanent magnetic poles. Preferably, the first arc surface 52a and the second arc surface 56a are commonly located on a cylindrical surface that is coaxial with the rotor, such that a substantially even gap 65 is formed between the permanent magnet 63 and the first arc surface 52a /second arc surface 56a (except for the areas of the positioning grooves 52b, 56b, and openings 53, 54, the gap at other areas is even). A thickness of the even gap 65 is 0.26 to 0.34 times the thickness of the permanent magnet 63.

A sensor 67 (FIG. 2) such as a Hall sensor is connected to the circuit board 50 (FIG. 1) through terminals, for detection the rotational position of the permanent magnet 63.

The stator windings 49 are wound around the first pole portion 52 and the second pole portion 56. In particular, the bracket 47 includes a hollow first mounting arm 48a and a hollow second mounting arm 48b extending toward ends of the first pole portion 52 and the second pole portion 56, respectively. The first pole portion 52 extends into the first mounting arm 48a, and the second pole portion 56 extends into the second mounting arm 48b. Each stator winding 49 is wound around an exterior of a corresponding one of the first mounting arm 48a and the second mounting arm 48b, i.e. the stator windings 49 and the first pole portion 52/the second pole portion 56 are spaced by the first mounting arm 48a and the second mounting arm 48b, respectively. Upon being energized, the stator windings 49 can produce two magnetic circuits that pass through the rotor.

Referring to FIG. 5, two circumferential ends of the first arc surface 52a form a first cutting surface 52c and a second cutting surface 52d, respectively. Two circumferential ends of the second arc surface 56a form a third cutting surface 56c and a fourth cutting surface 56d. The first slot opening 53 is formed between the first cutting surface 52c and the third cutting surface 56c, and the second slot opening 54 is formed between the second cutting surface 52d and the fourth cutting surface 56d.

The width of the slot opening 53 (i.e., a distance between the first cutting surface 52c and the third cutting surface 56c) is 0.09 to 0.13 times the outer diameter D1 of the rotor, and the width of the slot opening 54 (i.e., a distance between the second cutting surface 52d and the fourth cutting surface 56d) is also 0.09 to 0.13 times the outer diameter D1 of the rotor.

Preferably, a connecting line L1 connecting centers of the first slot opening 53 and the second slot opening 54 and the extension direction L2 of the first pole portion 52 form an angle Q of 60 to 65 degrees. More preferably, the connecting line connecting the centers of the first slot opening 53 and the second slot opening 54 and the extension direction of the second pole portion 56 form an angle of 60 to 65 degrees. When the angle between the lines L1 and L2 is less than 90 degrees, the first pole portion 52 is a non-symmetrical structure with respect to its center line L2, and the second pole portion 56 is also a non-symmetrical structure with respect to its center line. This configuration can reduce the induced potential of the motor, thereby increasing the output torque of the motor. Furthermore, the rotor is more easily started in one direction than in the other direction.

The first slot opening 53 and the second slot opening 54 are substantially the same in size and are symmetrical about the center of rotation of the rotor.

The first arc surface 52a has the first positioning groove 52b, and the second arc surface 56a has the second positioning groove 56b. An opening of the first positioning groove 52b faces toward the permanent magnet 63, and an opening of the second positioning groove 56b faces toward the permanent magnet 63. A width of the opening of the first positioning groove 52b and the second positioning groove 56b is 0.24 to 0.28 times the outer diameter D1 of the rotor. The term “width of the opening” as used herein refers to a size of the first positioning groove 52b and the second positioning groove 56b along a circumferential direction of the permanent magnet. A depth of the first positioning groove 52b into the first pole portion 52 and a depth of the second positioning groove 56b into the second pole portion 56 are both 0.015 to 0.035 times the outer diameter D1 of the rotor. A line connecting the first positioning groove 52b and the second positioning groove 56b coincides with center lines of the first pole portion 52 and the second pole portion 56.

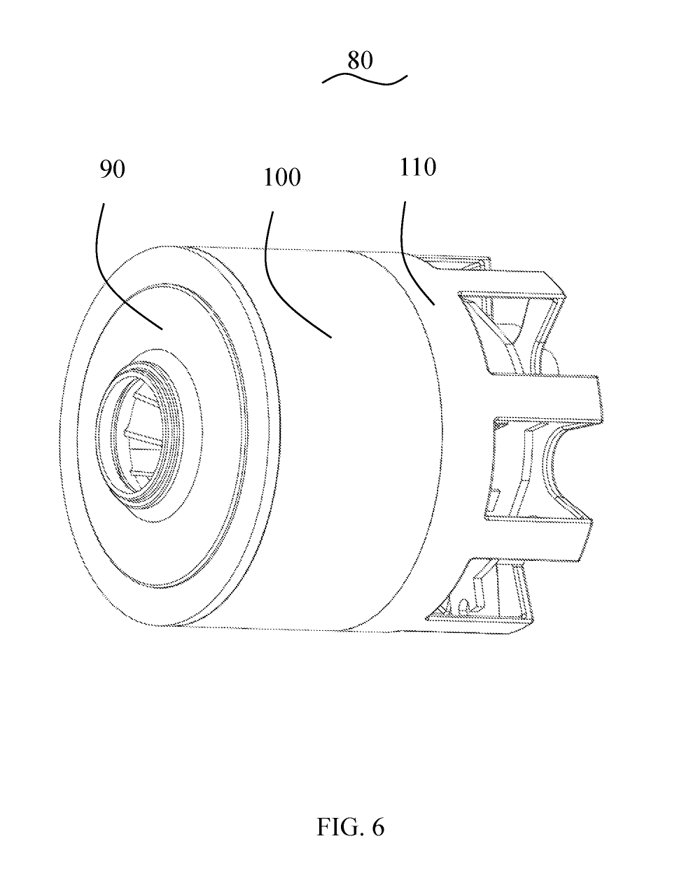

FIG. 6 illustrates an airflow generating device80 which employs the above-described single-phase motor 20. The airflow generating device80 further includes a centrifugal impeller 90 mounted on a rotary shaft of the single-phase motor 20, a diffuser 100 cooperating with the centrifugal impeller 90, and a diffuser accessory 110 cooperating with the diffuser 100.

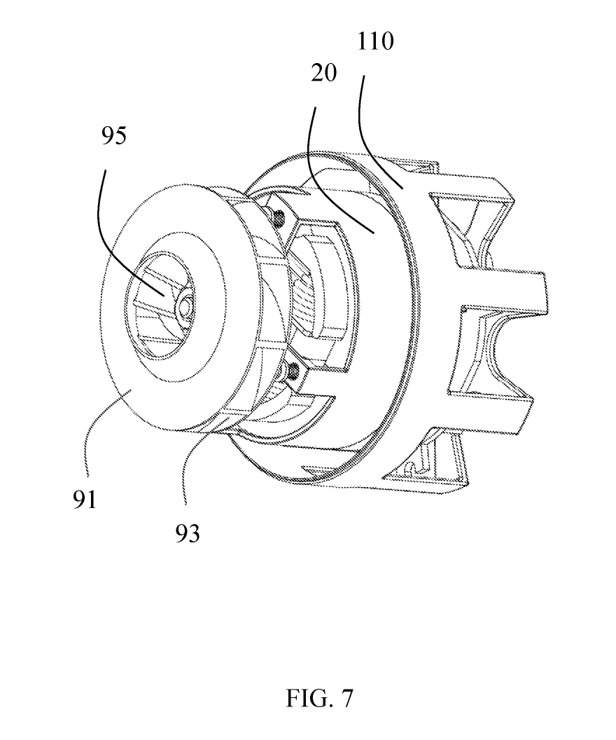

Referring to FIG. 7, the centrifugal impeller 90 includes a front cover plate 91 and a rear cover plate 93 that are spaced apart by a preset distance. The centrifugal impeller 90 further includes a plurality of blades 95 mounted between the front and rear cover plates 91, 93. Air passageways are formed between adjacent blades 95. The air passageways have an inlet at a center of the centrifugal impeller 90 and an outlet along an outer periphery of the centrifugal impeller 90.

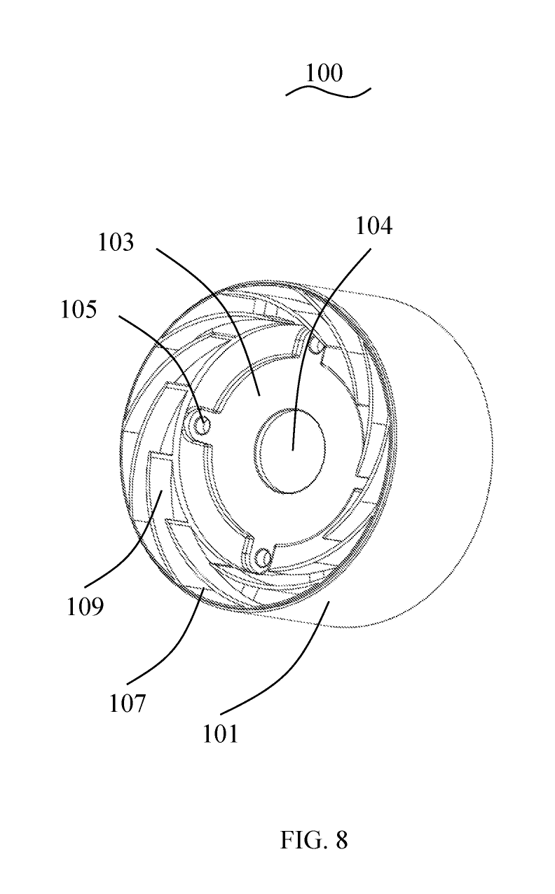

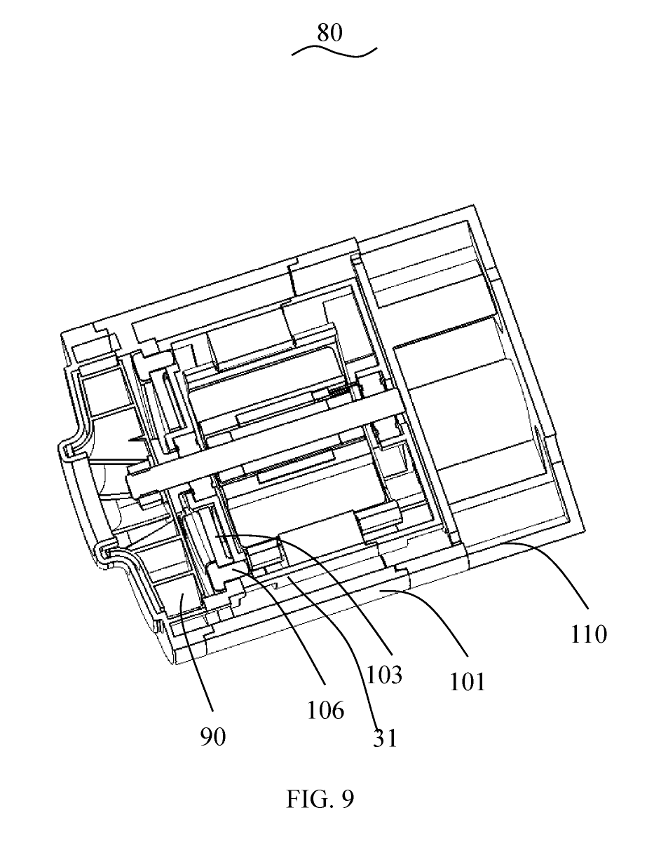

Referring to FIG. 8 and FIG. 9, the diffuser 100 includes a tubular outer housing 101, and a partition plate 103 disposed within the tubular outer housing 101. The partition plate 103 has a through bore 104 for allowing the rotary shaft of the motor 20 to pass there through. The partition plate 103 further includes a plurality of through holes 105 for allowing screws 106 to pass there through to mount the diffuser 100 to the housing 31 of the motor 20. Thus, the tubular outer housing 101 surrounds the motor 20, with a gap formed there between for forming a flow passage.

The diffuser 100 includes a plurality of diffusing fins 109 connected to the tubular outer housing 101. A diffusing channel 107 is formed between each two adjacent diffusing fins 109. The diffusing fins 109 are located surrounding the impeller 90, and inlet ends of the diffusing channels 107 are in flow communication with the outlet of the centrifugal impeller 90. In this embodiment, outlet ends of the diffusing channels 107 are in flow communication with the flow passage formed between the tubular outer housing 101 and the housing portions 31, 32 of the motor 20, such that the airflow is eventually guided to the diffusing accessory 110.

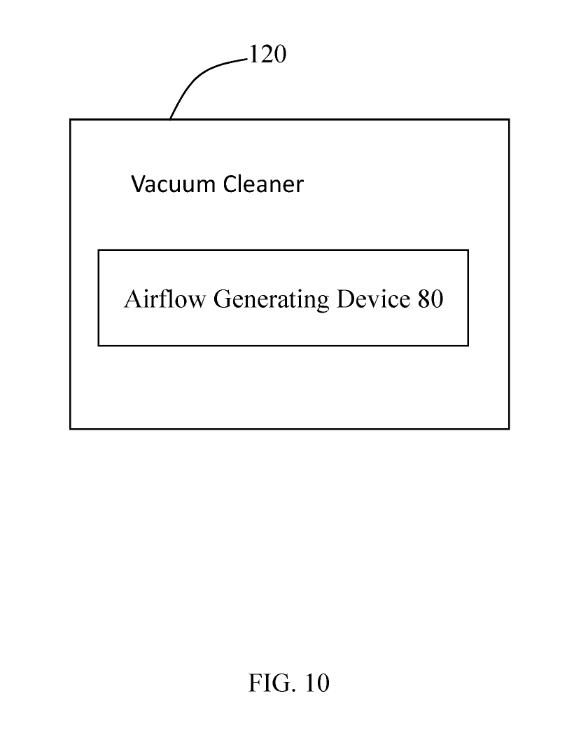

FIG. 10 illustrates a vacuum cleaner 120 which includes the airflow generating device as described above. In this embodiment, other parts of the vacuum cleaner 120 adopt known structures and therefore are not described herein in further detail.

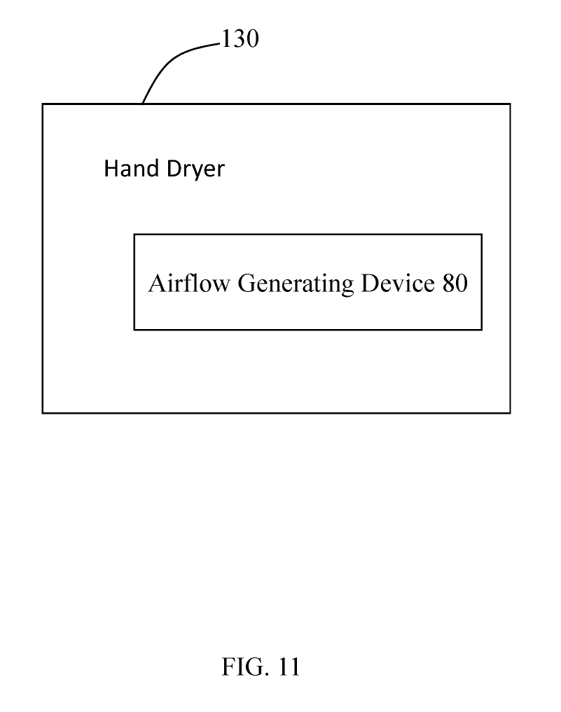

FIG. 11 illustrates a hand dryer 130 which includes the airflow generating device as described above. In this embodiment, other parts of the hand dryer 130 adopt known structures and therefore are not described herein in further detail.

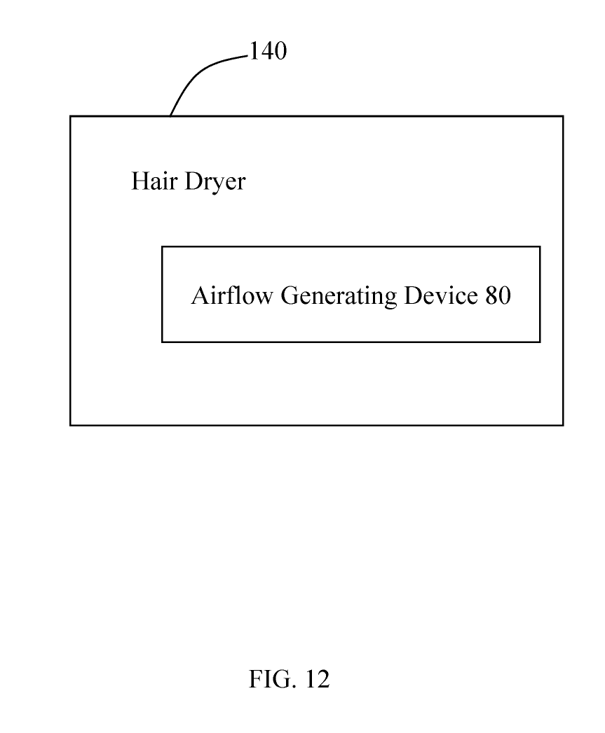

FIG. 12 illustrates a hair dryer 140 which includes the airflow generating device as described above. In this embodiment, other parts of the hair dryer 140 adopt known structures and therefore are not described herein in further detail.

It should be understood that the ring-shape of the ring-shaped yoke of the present invention includes circular ring shape, square ring shape, polygon ring shape or the like. The impeller of the airflow generating device is not intended to be limited to the centrifugal type. Rather, the impeller can be of another type, such as, an axial type. In this case, the airflow generating device can be used for other blowers such as a ventilating fan. It should be understood that the slot opening may be replaced by a magnetic bridge in some other embodiments. That is, adjacent pole portions are connected together via magnetic bridges which usually have narrow cross area and therefore large magnetic resistance.

Although the invention is described with reference to one or more preferred embodiments, it should be appreciated by those skilled in the art that various modifications are possible. Therefore, the scope of the invention is to be determined by reference to the claims that follow.

1. A single-phase motor comprising:
a rotor including a rotary shaft and a permanent magnet fixed to the rotary shaft; and
a stator including a stator core and stator windings wound around the stator core, the stator core including a yoke and a plurality of asymmetrical pole portions extending inwardly from the yoke, a magnetic bridge or slot opening being formed between each two adjacent pole portions, each pole portion including an end surface with an arc surface facing the rotor, a positioning groove being formed in each arc surface, the arc surfaces of the plurality of pole portions cooperatively forming a receiving cavity in which the permanent magnet is received.

2. The single-phase motor of claim 1, wherein the arc surfaces are located at a cylindrical surface centered around a rotation axis of the rotary shaft, the permanent magnet and the arc surfaces define a substantially even gap there between.

3. The single-phase motor of claim 2, wherein a slot opening is formed between each two adjacent pole portions, and a width of the slot opening is less than or equal to three times the width of the even gap.

4. The single-phase motor of claim 1, wherein a connecting line connecting a center of the magnetic bridge or slot opening and a center of the rotor and an extension direction of one of the pole portions form an angle of 60 to 65 degrees.

5. The single-phase motor of claim 1, wherein the plurality of pole portions includes a first pole portion and a second pole portion opposed to each other along a diametrical direction of the rotor, the end surface of the first pole portion comprises the first arc surface and first and second cutting surfaces on opposite sides of the first arc surface, the end surface of the second pole portion comprises the second arc surface and third and fourth cutting surfaces on opposite sides of the second arc surface, the first cutting surface and the third cutting surface are opposed to each other and define the first slot opening there between, and the second cutting surface and the fourth cutting surface are opposed to each other and define the second slot opening there between.

6. The single-phase motor of claim 5, wherein the first slot opening and the second slot opening have substantially the same size and are symmetrical about an axis of rotation of the rotor.

7. The single-phase motor of claim 5, wherein
a distance between the first cutting surface and the third cutting surface is 0.09 to 0.13 times an outer diameter of the rotor; and/or
a distance between the second cutting surface and the fourth cutting surface (56d) is 0.09 to 0.13 times the outer diameter of the rotor.

8. The single-phase motor of claim 1, wherein the stator core consists of a first half core portion and a second half core portion, the first half core portion forms a first half yoke portion and a first pole portion, the second half core portion forms a second half yoke portion and a second pole portion , and the first half yoke portion and the second half yoke portion are joined to form the ring-shaped yoke.

9. The single-phase motor of claim 2, wherein a thickness of the gap is 0.26 to 0.34 times a thickness of the permanent magnet.

10. The single-phase motor of claim 1, wherein a thickness of the permanent magnet is 0.2 to 0.24 times an outer diameter of the rotor.

11. The single-phase motor of claim 1, wherein a width of the pole portion is 1.4 to 1.6 times an outer diameter of the rotor.

12. The single-phase motor of claim 1, wherein the yoke is a ring-shaped yoke and a thickness of the ring-shaped yoke is 0.5 to 0.7 times an outer diameter of the rotor.

13. The single-phase motor of claim 1, wherein the positioning groove has an opening facing toward the permanent magnet, and a width of the opening of the positioning groove is 0.24 to 0.28 times an outer diameter of the rotor.

14. The single-phase motor of claim 1, wherein the positioning groove has an opening facing toward the permanent magnet, and a depth of the positioning groove into the corresponding pole portion is 0.015 to 0.035 times an outer diameter of the rotor.

15. The single-phase motor of claim 1, wherein a center of the positioning groove is aligned with a center line of a corresponding pole portion, and the end surface of the pole portion is asymmetrical about the center line of the pole portion.

16. The single-phase motor of claim 1, wherein the stator further includes a housing having two half housing portions, each half housing portion includes a cylindrical sleeve, a hub disposed at an outer end of the cylindrical sleeve, and a plurality of spokes connected between the cylindrical sleeve and the hub; a bearing is mounted in the hub the stator core is mounted to an inner wall surface of the cylindrical sleeve, opposite ends of the rotary shaft extend through the hubs of the two half housing portions and are supported by the bearings mounted in the hub, respectively.

17. An airflow generating device comprising:
an impeller; and
a single-phase motor, the single-phase motor including
a rotor including a rotary shaft for driving the impeller, and a permanent magnet fixed to the rotary shaft; and
a stator including a stator core and stator windings wound around the stator core, the stator core including a yoke and a plurality of asymmetrical pole portions extending inwardly from the yoke, a magnetic bridge or slot opening being formed between each two adjacent pole portions, an end surface of each pole portion including an arc surface opposed to the rotor, a positioning groove being formed in each arc surface, the arc surfaces of the plurality of pole portions cooperatively forming a receiving cavity in which the permanent magnet is received, the arc surfaces being located on a cylindrical surface centered around a rotation axis of the rotary shaft.

18. The airflow generating device of claim 17, wherein the impeller is a centrifugal impeller which includes an inlet, an outlet along an outer periphery of the impeller, and air passageways communicated between the inlet and the outlet, the airflow generating device further includes a diffuser disposed surrounding the centrifugal impeller, the diffuser includes a plurality of diffusing channels, and inlet ends of the diffusing channels are in flow communication with the outlet of the centrifugal impeller.

19. The airflow generating device of claim 18, wherein the diffuser includes a cylindrical outer housing and a partition plate disposed within the outer housing, the partition plate is mounted to the single-phase motor, the cylindrical outer housing surrounds the single-phase motor, the partition plate has a through bore for allowing the rotary shaft of the single-phase motor to pass there through, and the diffusing channels extend through the partition plate.

20. An electric apparatus comprising an airflow generating device of claim 17.

21. The electric apparatus of claim 20, wherein the electric apparatus is a vacuum cleaner or a hand dryer or a hair dryer.
